(19) United States
(12) Patent Application Publication
(10) Pub. No.: US 2024/0418389 A1
(43) Pub. Date: Dec. 19, 2024

(54) HEATING VENTILATION AND AIR CONDITIONING SYSTEM FOR GENERATING FIRE ALERTS AND METHOD THEREOF

(71) Applicant: Carrier Corporation, Palm Beach Gardens, FL (US)

(72) Inventors: Sriram Atluri, Hyderabad (IN); Ramesh Babu Muniandy, Hyderabad (IN); David Mannfeld, Carmel, IN (US)

(21) Appl. No.: 18/732,827

(22) Filed: Jun. 4, 2024

Related U.S. Application Data
(60) Provisional application No. 63/508,715, filed on Jun. 16, 2023.

(51) Int. Cl. F24F 11/64; F24F 11/52; F24F 110/12

(52) U.S. Cl. CPC F24F 11/64; F24F 11/52; F24F 2110/12

(57) ABSTRACT

Embodiments of the disclosure describe a Heating Ventilation and Air Conditioning (HVAC) system and method for generating fire alerts for an indoor environment having a plurality of zones. The method comprises receiving, from an outside air temperature (OAT) sensor of the HVAC system, a current outside temperature value for an outdoor environment. Further, the method comprises receiving, from a zone sensor associated with the HVAC system, a current zone temperature value associated with a corresponding zone, from among the plurality of zones, in the indoor environment. Furthermore, the method comprises detecting, when the current zone temperature value is greater than the current outside temperature value, whether a rate of change of the current zone temperature value is greater than a predefined threshold value. Additionally, the method comprises generating a fire alert for the zone based on the detection step.

### CROSS REFERENCE TO RELATED APPLICATION

This application claims the benefit of U.S. Provisional Patent Application No. 63/508,715 filed on Jun. 16, 2023, which is incorporated by reference herein in its entirety.

### FIELD OF THE INVENTION

The disclosure generally relates to heating ventilation and air conditioning (HVAC) systems, and more particularly relates to HVAC systems and methods for generating fire alerts for an indoor environment having a plurality of zones.

### BACKGROUND

Generally, all residential, commercial, or industrial buildings/premises are monitored for smoke and/or fire. Conventional systems to detect smoke/fire include smoke/fire detectors which are usually placed in areas susceptible to fire. For example, generally, there are one or two smoke/fire detectors installed for an entire residential area. Due to such a limited number of fire detectors, there is a lot of scope for improvement in some areas which are not monitored for smoke/fire. Even though a substantial number of residential/commercial buildings having smoke/fire sensors, there have been several instances where alerts related to smoke/fire are not generated by such conventional systems. The key reason behind the non-generation of such alerts is due to smoke/fire being out of range of the smoke/fire detectors.

To address the above-mentioned challenges, a conventional solution is to install more smoke/fire detectors to cover all areas within a premise/building. However, such conventional solution would be costly and cumbersome due to installation of additional sensors in existing buildings/premises.

Thus, there is a need to address the aforementioned shortcomings of currently deployed smoke/fire detectors and provide a cost-effective as well as efficient methodology to detect smoke/fire within premises/buildings.

### SUMMARY

This summary is provided to introduce a selection of concepts, in a simplified format, that are further described in the detailed description of the disclosure. This summary is neither intended to identify key or essential inventive concepts of the disclosure and nor is it intended for determining the scope of the disclosure.

Disclosed herein is a method of generating fire alerts for an indoor environment having a plurality of zones and a heating ventilation and air conditioning (HVAC) system. The method comprises receiving, from an outside air temperature (OAT) sensor of the HVAC system, a current outside temperature value for an outdoor environment. Further, the method comprises receiving, from a zone sensor associated with the HVAC system, a current zone temperature value associated with a corresponding zone, from among the plurality of zones, in the indoor environment. Furthermore, the method comprises determining whether the current zone temperature value is greater than the current outside temperature value. Furthermore, the method comprises detecting, when the current zone temperature value is greater than the current outside temperature value, whether a rate of change of the current zone temperature value is greater than a predefined threshold value. Additionally, the method comprises generating a fire alert for the zone when the rate of change of the current zone temperature value is detected to be greater than the predefined threshold value.

In one or more embodiments, generating the fire alert comprises generating a first alert notification for one of a graphical user interface (GUI) associated with the HVAC system or a third-party fire safety control system, wherein the first alert notification is indicative of fire within the zone.

In one or more embodiments, the method further comprises triggering a first control action associated with controlling a movement of a damper associated with at least one zone, from among the plurality of zones, of the HVAC system. In one or more embodiments, triggering the first control action comprises closing a damper associated with at least one zone other than the zone, from among the plurality of zones, thereby minimizing flow of smoke from the zone to the at least one other zone. In one or more other embodiments, triggering the first control action comprises closing a damper associated with the zone, from among the plurality of zones, thereby minimizing flow of smoke from the zone to the at least one other zone.

In one or more embodiments, the method further comprises triggering a second control action associated with the HVAC system. The second control action comprises supplying fresh air from the outdoor environment to at least one zone, from among the plurality of zones, while operating the HVAC system.

In one or more embodiments, the detecting comprises iteratively detecting, over a period of time, that the rate of change of the current zone temperature value is greater than the predefined threshold value when the current zone temperature value is detected to be greater than the current outside temperature value. In one or more embodiments, the generating comprises generating the fire alert for the zone in response to detecting, over the period of time, a predefined number of times that the rate of change of the current zone temperature value is greater than the predefined threshold value.

Also disclosed herein is a heating ventilation and air conditioning (HVAC) system to generate fire alerts for an indoor environment having a plurality of zones. The HVAC system comprises at least one HVAC equipment, and at least one control device communicatively connected with the at least one HVAC equipment. The at least one control device comprises a processor configured to, for each of the plurality of zones, receive, from an outside air temperature (OAT) sensor of the HVAC equipment, a current outside temperature value for an outdoor environment. Further, the processor is configured to, for each of the plurality of zones, receive, from a corresponding zone sensor associated with the HVAC equipment, a current zone temperature value associated with a corresponding zone, from among the plurality of zones, in the indoor environment. Furthermore, the processor is configured to, for each of the plurality of zones, determine whether the current zone temperature value is greater than the current outside temperature value. Furthermore, the processor is configured to, for each of the plurality of zones, detect, when the current zone temperature value is greater than the current outside temperature value, whether a rate of change of the current zone temperature value is greater than a predefined threshold value. In addition, the processor is configured to, for each of the plurality of zones, generate a fire alert for the zone when the rate of change of the current zone temperature value is detected to be greater than the predefined threshold value.

In one or more embodiments, to generate the fire alert, the processor is configured to generate a first alert notification for one of a graphical user interface (GUI) associated with the HVAC system or a third-party fire safety control system, wherein the first alert notification is indicative of fire within the zone.

In one or more embodiments, the processor is further configured to trigger a first control action associated with controlling a movement of a damper associated with at least one zone, from among the plurality of zones, of the HVAC system.

In one or more embodiments, to trigger the first control action, the processor is configured to close a damper associated with at least one zone other than the zone, from among the plurality of zones, thereby minimizing flow of smoke from the zone to the at least one other zone.

In one or more embodiments, to trigger the first control action, the processor is configured to close a damper associated with the zone, from among the plurality of zones, thereby minimizing flow of smoke from the zone to the at least one other zone.

In one or more embodiments, the processor is further configured to trigger a second control action associated with the HVAC system. The second control action comprises supplying fresh air from the outdoor environment to at least one zone, from among the plurality of zones, while operating the HVAC system.

In one or more embodiments, the processor is further configured to iteratively detect, over a period of time, that the rate of change of the current zone temperature value is greater than the predefined threshold value when the current zone temperature value detected to be is greater than the current outside temperature value. Further, the at least one control device is configured to generate the fire alert for the zone in response to detecting, over the period of time, a predefined number of times that the rate of change of the current zone temperature value is greater than the predefined threshold value.

To further clarify the advantages and features of the methods, systems, and apparatuses, a more particular description of the methods, systems, and apparatuses will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

These and other features, aspects, and advantages of the disclosure will become better understood when the following detailed description is read with reference to the accompanying drawings in which like characters represent like parts throughout the drawings, wherein:

FIG. 1A illustrates an environment associated with a system for generating fire alerts for an indoor environment having a plurality of zones, according to one or more embodiments of the disclosure;

FIG. 1B illustrates the environment associated with the system for generating the fire alerts for the indoor environment having the plurality of zones comprising dampers, according to one or more embodiments of the disclosure;

FIG. 2 illustrates a schematic block diagram of the HVAC system for generating fire alerts for the indoor environment having the plurality of zones, according to one or more embodiments of the disclosure; and

FIG. 3 illustrates a process flow depicting a method for generating fire alerts for the indoor environment having the plurality of zones, according to one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment”, “some embodiments”, “one or more embodiments” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

For overcoming the aforementioned challenges of limited smoke/fire detectors, the disclosure provides a system and method to use existing thermostat zone sensors which are placed at pre-defined locations within a premises/building area. Specifically, HVAC systems are installed in residential, commercial, or industrial buildings. The HVAC systems maintain temperature and provide proper airflow within/inside the building area. The HVAC systems may provide heated or cooled air within/inside the building to adjust the temperature therewithin. Further, in the HVAC systems, the concept of zoning helps in achieving better energy efficiency and control on a need basis. This zoning requires placement of zone sensors at all designated zones of a premise.

Embodiments of the disclosure will be described below in detail with reference to the accompanying drawings.

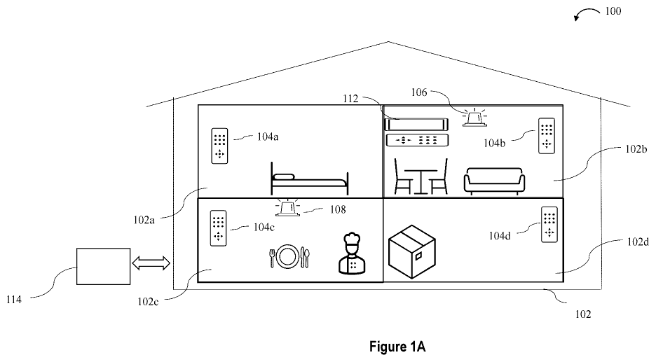

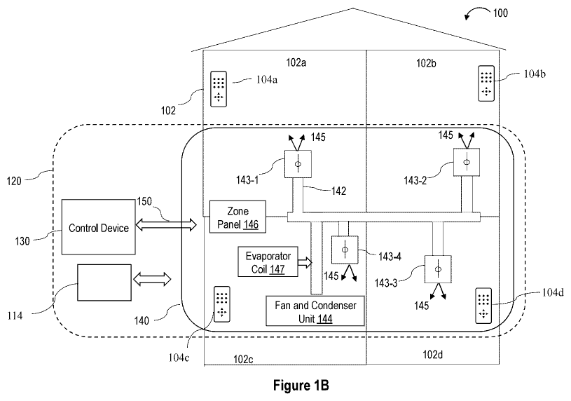

FIG. 1A illustrates an environment 100 associated with a system for generating fire alerts for an indoor environment 102 having a plurality of zones 102a-102d, according to one or more embodiments of the disclosure. FIG. 1B illustrates the environment 100 associated with the system for generating fire alerts for the indoor environment 102 having the plurality of zones 102a-102d comprising dampers 143-1 to 143-4, according to one or more embodiments of the disclosure. FIGS. 1A and 1B are described in conjunction with each other for the sake of brevity.

The system environment 100 may include an indoor area/environment 102 and an HVAC system 120. The HVAC system 120 may comprise a control device 130 and an HVAC equipment 140. In an embodiment, the control device 130 may be in communication with one or more components of the HVAC equipment 140, as discussed below herein throughout the disclosure.

The indoor environment 102 may relate to an indoor environment of a residential, industrial, or commercial property. The indoor environment 102 may comprise a plurality of zones 102a to 102d as shown in FIGS. 1A and 1B. While FIG. 1B only illustrates four zones, i.e., zones 102a-102d, it may be understood that the indoor environment 102 may include more or less than four zones. The respective zones of the plurality of zones 102a-102d may correspond to, but not limited to, a living room area, a bedroom, a family room, a conference room, a garage, a kitchen, and the like. As depicted in FIG. 1A, zone 102a may correspond to a bedroom, zone 102b may correspond to a living room, zone 102c may correspond to kitchen area, and zone 102d may correspond to a store room. Zones 102a-102d, as shown in FIGS. 1A and 1B, are non-limiting in scope and exemplary. A person skilled in the art would understand that the system environment 100 may include other zones as well, without deviating from the scope of the disclosure.

Additionally, each of the plurality of zones 102a-102d may include a zone sensor 104a-104d, respectively. Each of the plurality of zone sensors 104a-104d may be configured to measure/sense a current temperature value associated with the corresponding zone, from among the plurality of zones, in the indoor environment. In one embodiment, the plurality of zone sensors 104a-104d may comprise, but not limited to, thermistors, resistance temperature detectors (RTDs), thermocouples, infrared sensors, and any other temperature sensor. The RTDs may sense ambient air temperature in the indoor environment 110. Furthermore, the HVAC system 120 may further comprise an outside air temperature (OAT) sensor 114. The OAT sensor 114 may be configured to measure a current outside temperature value for an outdoor environment. The outdoor environment may correspond to an area outside the indoor environment 102, i.e., an area outside a building/premises which is not controlled for heating/cooling by the HVAC system 120. In an embodiment of the disclosure, the OAT sensor 140 may be configured to measure a real-time environmental temperature of the outdoor environment.

Additionally, one or more zones, for example, zone 102b and 102c may include smoke/fire sensors 106, 108. The smoke/fire sensors 106, 108 are merely shown for illustrative purposes, and are not being used for generating fire alerts in accordance with the embodiments of the disclosure. In one or more embodiments of the disclosure, the fire alerts are generated using inputs from zone sensors 104a-104d and OAT sensor 114, as discussed herein throughout the disclosure.

In one or more embodiments, at least one of the plurality of zones 102a-102d may include a thermostat 112, associated with the HVAC system 120. The thermostat 112 may be configured to receive inputs associated from the zone sensors 104a-104d. In an embodiment, the thermostat 112 may be further configured to process inputs associated with the temperature values and perform one or more method(s) to detect fire, as discussed throughout the disclosure. The zone sensors 104a-104d may be associated with the thermostat zone sensors, which are placed at pre-defined locations within a premise/facility associated with an indoor environment.

The HVAC equipment 140 may comprise the plurality of zone sensors 104a-104d disposed in the indoor environment 102. As discussed above, a corresponding zone sensor among the plurality of zone sensors may be disposed in each of the plurality of zones 102a-102d. The HVAC equipment 140 may further comprise a ductwork arrangement 142 disposed in the indoor environment 102, wherein the ductwork arrangement 142 may be configured to allow the flow of conditioned air therethrough. The ductwork arrangement 142 may be disposed in the indoor environment 102 so as to provide conditioned air to each of the plurality of zones 102a-102d. In an embodiment, the ductwork arrangement 142 may comprise a central duct and a plurality of extension ducts extending from the central duct. The plurality of extension ducts may extend to the corresponding zones of the plurality of zones 102a-102d, thereby providing the conditioned air to the corresponding zones.

The HVAC equipment 140 may further comprise one or more dampers 143-1 to 143-4. Each of the dampers 143-1 to 143-4 may be configured to adjust the flow of conditioned air to the indoor environment 102. In an embodiment, each of the plurality of zones 102a-102d may be associated with a corresponding damper of the one or more dampers 143-1 to 143-4 such that the corresponding dampers adjust the flow of conditioned air to the associated zone. In an embodiment, the one or more dampers 143-1 to 143-4 may be associated with a damper mechanism that may be configured to mechanically move or adjust the corresponding dampers 143-1 to 143-4. In an embodiment, the damper mechanism may be movable to open and/or close the corresponding dampers 143-1 to 143-4.

The HVAC equipment 140 may further comprise a fan and condenser unit 144, and an evaporator coil 147 coupled to the ductwork arrangement 142. The fan and condenser unit 144 may be configured to circulate conditioned air through the ductwork arrangement 142. As can be seen in FIG. 1B, conditioned air 145 may flow through the ductwork arrangement 142 to each of the plurality of zones 102a-102d. The evaporator coil 147 may absorb heat from conditioned air that passes through the ductwork arrangement 142 and then cools the conditioned air and removes moisture from the conditioned air.

The HVAC equipment 140 may further comprise a zone panel 146. The zone panel 146 may be communicatively coupled to the plurality of zone sensors 104a-104d and the one or more dampers 143-1 to 143-4. In an embodiment, the zone panel 146 may be configured to provide power to the one or more dampers 143-1 to 143-4 and/or the plurality of zone sensors 104a-104d. In an embodiment, the zone panel 146 may be coupled to the one or more zone sensors 104a-104d in a wired manner. In an embodiment, the zone panel 146 may be further coupled to the one or more dampers 143-1 to 143-4 in the wired manner.

In one or more embodiments, one or more components of the HVAC equipment 140 may be communicatively coupled to the control device 130 via a communication network 150. For instance, in one embodiment, the zone panel 146 may be in communication with the control device 130. The zone panel 146 may receive readings from the zone sensors 104a-104d and may provide the readings to the control device 130. The zone panel 146 may receive control commands from the control device 130 and control movement of the dampers 143-1 to 143-4 based on the control commands. In another embodiment, the one or more zone sensors 104a-104d may be in direct communication with the control device 130 so as to send readings indicative of the temperature of the corresponding zone directly to the control device 130. Further, in an embodiment, the fan and condenser unit 144 may be in communication with the control device 130.

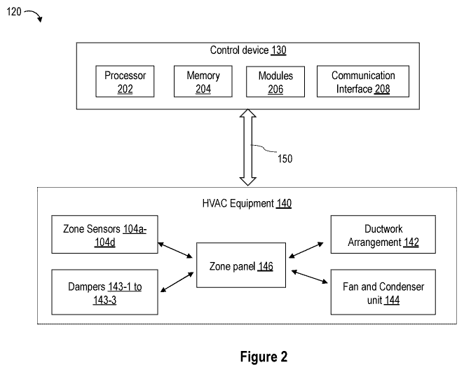

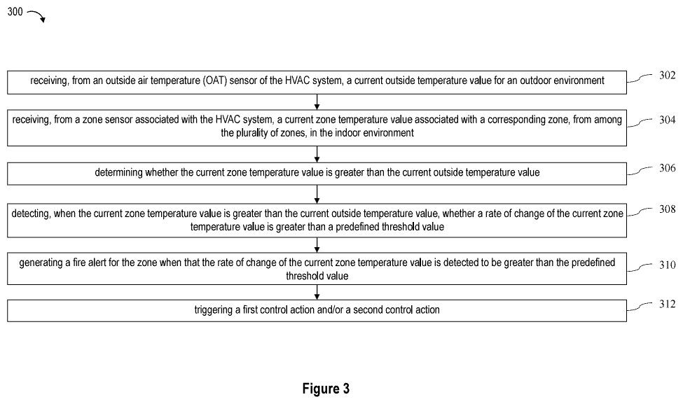

In operation, the HVAC system 120 may be configured to generate fire alerts for the indoor environment 102 having the plurality of zones 102a-102d. Further, the at least one control device 130 of the HVAC system 120 may be communicatively coupled to the at least one HVAC equipment 140 of the HVAC system 120. The at least one control device 130 may include a processor (not shown in FIGS. 1A and 1B) configured to, for each of the plurality of zones 102a-102d, receive, from the outside air temperature (OAT) sensor 114 of the HVAC equipment 140, a current outside temperature value for the outdoor environment. Further, the processor is configured to, for each of the plurality of zones 102a-102d, receive, from a corresponding zone sensor associated with the HVAC equipment 140, a current zone temperature value associated with a corresponding zone, from among the plurality of zones 102a-102d, in the indoor environment 102. Furthermore, the processor is configured to, for each of the plurality of zones 102a-102d, determine whether the current zone temperature value is greater than the current outside temperature value. Furthermore, the processor is configured to, for each of the plurality of zones 102a-102d, detect, when the current zone temperature value is greater than the current outside temperature value, whether a rate of change of the current zone temperature value is greater than a predefined threshold value. In addition, the processor is configured to, for each of the plurality of zones 102a-102d, generate a fire alert for the zone when the rate of change of the current zone temperature value is detected to be greater than the predefined threshold value. Additionally, one or more control actions may be triggered in response to detection of fire within a zone of the plurality of zones 102a-102d. A detail description related to these operations is discussed in detail in forthcoming paragraphs in conjunction with FIGS. 2 and 3.

In one embodiment, the fire alerts may be generated as visual alarms to be displayed on one or more user devices (not shown). Alternatively, the fire alerts may be generated as audio alarms. In one or more embodiments, the generated fire alerts may be similar to generating fire alerts by conventional smoke/fire sensors. Thus, the HVAC system 120 and/or the thermostat 112 may be configured to notify the user(s) remotely/locally based on such alerts.

In one embodiment, the generation of fire alerts and triggering of control actions may be performed at the thermostat 112. In another embodiment, the generation of fire alerts and triggering of control actions may be performed at a cloud-based server (not shown) in communication with the HVAC system 120, where the data associated with temperature values may be transmitted from the zone sensors 104a-104d and OAT sensor 114 to the cloud-based server, either directly or via the thermostat 112. In yet another embodiment, the generation of fire alerts and triggering of control actions may be performed at the zone sensors 104a-104d. In yet another embodiment, the generation of fire alerts and triggering of control actions may be performed at the control device 130, as discussed in conjunction with FIG. 2. It may be apparent to a person skilled in the art that the method(s) discussed in FIG. 2 for generation of fire alerts and triggering of control actions at the control device 130 may be analogously performed by a cloud-based server and zone sensors, when such method(s) are performed at the cloud-based server and zone sensors, respectively.

In one embodiment, the generation of fire alerts (associated with fire-based event) and triggering of control actions may be performed at the cloud-based server in conjunction with data from one or more smoke/fire sensor(s) within the same premises/facility. In the same embodiment, the fire alert generation may be a two-step method, where in the first step, data from the zone sensors 104a-104d and the OAT sensor 114 may be used detect fire. In the second step, data from one or more smoke sensor(s) associated with the same premise/facility may be used to verify fire-based event.

In one embodiment, the disclosed method to generate fire alerts may be performed as a semi-automated smoke/fire alarm wherein, upon notification from the thermostat 112 or the control device 130 or a cloud-based server, a user may confirm presence of fire, and the user may manually activate a fire button provided at the thermostat 112 (or an associated software application), and the thermostat 112 may raise alarm to a fire station. This may facilitate in protecting premises/buildings from fire even with no fire/smoke sensors.

FIG. 2 illustrates a schematic block diagram of the HVAC system 120 for generating fire alerts for an indoor environment having plurality of zones 102a-102d, according to one or more embodiments of the disclosure.

As shown in FIG. 2, the control device 130 is in communication with one or more components of the HVAC equipment 140. In one or more embodiments, the control device 130 may comprise a processor 202, a memory 204, one or more modules 206, and a communication interface 208.

The processor 202 may be configured to communicate with the memory 204 to store temperature related data, such as received readings from the zone sensors 104a-104d and the OAT sensor 114, for determining any fire related events within the indoor environment 102. In one or more embodiments, the processor 202 may be one or more microprocessor(s) or microcontroller(s). The processor 202 may include one or a plurality of processors, may be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

In some embodiments, the memory 204 may store data and instructions executable by the processor(s) 202 to perform the method steps for detecting fire related events, generating fire alerts for the indoor environment 102, and triggering control actions, as discussed herein throughout the disclosure. The memory 204 may further include, but not limited to, a non-transitory computer-readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. Further, the non-transitory computer-readable storage media of the memory 204 may include executable instructions in a form of the modules 206 and a database to store data. The modules 206 may include a set of instructions that may be executed to cause the processor 202 to perform any one or more of the methods for generating fire alerts for the indoor environment, as disclosed herein throughout the disclosure. Specifically, the modules 206 may be configured to perform the steps of the disclosure using the data stored in the database of the memory 204 for generating fire alerts and triggering control actions for controlling fire in the indoor environment 102. In another embodiment, the modules 206 may be one or more hardware units that may be outside the memory 204. In one embodiment, the memory 204 may communicate via a bus within the processor(s) 202.

In one or more embodiments, the communication interface 208 may include a transmitter and a receiver, and may be configured to communicate with one or more components of the HVAC equipment 140, such as the zone panel 146, the plurality of zone sensors 104a-104d, and/or the fan and condenser unit 144, via the communication network 150. The communication via the communication network 150 may be based on a wireless communication protocol. The communication interface 208 coupled with the processor 202 may be configured to transmit an alert indicating a fire related event within one or more zones of the plurality of zones 102a-102d. The communication interface 208 may be configured for communicating internally between internal hardware components and with external devices, e.g., the HVAC equipment 140, via one or more networks (e.g., radio technology). The communication interface 208 may include an electronic circuit specific to a standard that may enable wireless communication.

Referring to FIGS. 1A, 1B, and 2, the processor 202 may be configured to generate fire alerts and trigger control actions for controlling fire in the indoor environment 102. In one or more embodiments, the processor 202 may be configured to generate fire alerts for each of the plurality of zones 102a-102d, within the indoor environment 110. The processor 202 may be further configured to detect, via the corresponding zone sensors 104a-104d, over a period of time, a current temperature value of each corresponding zone of the plurality of zones 102a-102d. The processor 202 may be further configured to process the measurements received from the zone sensors 104a-104d of the corresponding zones and OAT sensor 114 in order to detect any fire-based events and trigger associated control actions.

The disclosure provides for a provision to configure predefined threshold temperature value(s), and the rate of change may only be monitored after the threshold value is breached. For example; if the room temperature is 16 degrees Celsius, and in case of power failure, an opening of door(s)/window(s) would trigger raise in temperature. However, the absolute temperature may be, for example, around 20 degrees Celsius. Such a scenario should not trigger an alarm. To avoid such fake fire alarm issues, the disclosure utilizes comparing current temperature values recorded over a period of time with a real-time outdoor temperature derived from the OAT sensor 114 of the HVAC system 120 and considering the rate of raise above that OAT value.

The current temperature values may be indicative of actual temperature values within the corresponding zones that are being sensed by the temperature sensors 104a-104d installed in the corresponding zones. For instance, considering zones 102a-102d, the current temperature value of the zone 102a may be the actual temperature of the zone 102a that is detected by the temperature sensor 104a installed within the zone 102a.

In an embodiment, for each of the plurality of zones 104a-104d, one or more temperature set point ranges may be stored in the memory 204. The HVAC equipment 140 may be configured to maintain the actual temperature of the corresponding zones within the set point range.

In an embodiment, the HVAC system 120 may be configured to operate in a heating mode and a cooling mode. In the heating mode, the HVAC system 120 may provide conditioned air to heat the indoor environment 102. In the cooling mode, the HVAC system 120 may provide conditioned air to cool the indoor environment 102.

In an embodiment, the processor 202 may be configured to operate in the heating mode or the cooling mode based on a user input. The processor 202 may be configured to receive the user input corresponding to one of the heating or cooling of the corresponding zone. The user input may correspond to an input provided by a user of the HVAC system 120. The input may correspond to a selection of a heating operation or a cooling operation for heating or cooling the corresponding zones. Based on the reception of the user input, the processor 202 may be configured to maintain the actual temperature within the set point range for the corresponding zone. Further, the processor 202 may be configured to detect the current temperature value for each zone, and compare the current temperature value with the detected current outside temperature value for the outdoor environment. In an embodiment, the user input may be received via a user device, such as a smart phone, a remote device, or a pre-installed device within the corresponding zones, such as a thermostat or a smart sensing device.

In an embodiment, for each of the plurality of zones 102a-102d, predefined threshold temperature values may be stored in the memory 204. After determining that the current zone temperature value is greater than the current outside temperature value, the processor 202 may be further configured to compare a rate of change of the current temperature value of the corresponding zones with the stored predefined threshold value.

The HVAC system 120 may be configured to generate a fire alert for a zone when the rate of change of the current zone temperature value is detected to be greater than the predefined threshold value. For example, a rate of rise in room temperature within a range of 6.7 degree Celsius to 8.3 degree Celsius per minute may be considered as a possible fire related event. The fire alert generation may include a first alert notification for one of a graphical user interface (GUI) associated with the HVAC system 120 or a third-party fire safety control system (e.g., a municipal fire agency). The first alert notification is indicative of fire within the zone.

Further, the HVAC system 120 may be configured to trigger one or more control actions associated with controlling a movement of one or more dampers 143-1 to 143-4 associated with at least one zone of the HVAC system 120. In an embodiment, triggering the control action(s) associated with controlling the movement of dampers 143-1 to 143-4 may include closing a damper associated with at least one zone other than the zone, from among the plurality of zones 102a-102d, thereby minimizing flow of smoke from the zone to the at least one other zone. In another embodiment, triggering the control action(s) associated with controlling the movement of dampers 143-1 to 143-4 may include closing a damper associated with the zone where fire has been detected, from among the plurality of zones 102a-102d, thereby minimizing flow of smoke from the zone to the at least one other zone. In one or more embodiments, a second control action associated with the HVAC system 120 may be triggered. The second control action may comprise supplying fresh air from the outdoor environment to at least one zone, from among the plurality of zones 102a-102d, while operating the HVAC system 120.

In one or more embodiments, the processor 202 may be further configured to generate a first alert notification when the first control action is triggered. The first alert notification may be displayed on the GUI associated with the HVAC system 120. For instance, the HVAC system 120 may comprise a thermostat and/or a smart sensor device installed within each of the plurality of zones 102a-102d, and for the corresponding zones, the first alert notification may be displayed by the thermostat 112 of the HVAC system 120. In one or more embodiments, the first alert notification may be indicative of a fire related event within a corresponding zone among the plurality of zones 102a-102d. For instance, the first alert notification may comprise information related to fire that allows the user within/outside the corresponding zone to be aware of such events.

In an embodiment, the processor 202 may be configured to automatically monitor a change in the rate of change of current temperature value within a particular zone among zones 102a-102d. The processor 202 may be further configured to determine whether the current temperature value reaches the predefined threshold value for the particular zone based on the monitoring of the change in the current temperature value. The processor 202 may be further configured to trigger, in response to the determination that the current temperature value reaches the first threshold value, the first control action for the particular zone for which the rate of change of current temperature value reaches the predefined threshold value.

In another embodiment, another control action relates to shutting down the HVAC equipment 140 of the HVAC system 120. The processor 202 may be configured to control the operation of the HVAC system 120 to cease or shut down the HVAC equipment 140. As a result, the heating/cooling for the entire indoor environment 110 is ceased.

FIG. 3 illustrates a process flow depicting a method 300 for generating fire alerts for the indoor environment having the plurality of zones, according to one or more embodiments of the disclosure.

At step 302, the method 300 comprises receiving, from an outside air temperature (OAT) sensor of the HVAC system, a current outside temperature value for an outdoor environment.

At step 304, the method 300 comprises receiving, from a zone sensor associated with the HVAC system, a current zone temperature value associated with a corresponding zone, from among the plurality of zones, in the indoor environment.

At step 306, the method 300 comprises determining whether the current zone temperature value is greater than the current outside temperature value.

At step 308, the method 300 comprises detecting, when the current zone temperature value is greater than the current outside temperature value, whether a rate of change of the current zone temperature value is greater than a predefined threshold value. In an embodiment of the disclosure, the detecting may comprise iteratively detecting, over a period of time, that the rate of change of the current zone temperature value is greater than the predefined threshold value when the current zone temperature value is detected to be greater than the current outside temperature value.

At step 310, the method 300 comprises generating a fire alert for the zone when the rate of change of the current zone temperature value is detected to be greater than the predefined threshold value. In an embodiment of the disclosure, generating the fire alert comprises generating a first alert notification for one of the GUI associated with the HVAC system or a third-party fire safety control system, wherein the first alert notification is indicative of fire within the zone.

In an embodiment where the detecting step 308 comprises iteratively detecting, over a period of time, that the rate of change of a zone temperature value is greater than the predefined threshold value, the generating step 310 may comprise generating the fire alert for the zone in response to detecting, over the period of time, a predefined number of times that the rate of change of the current zone temperature value is greater than the predefined threshold value.

At step 312, the method 300 comprises triggering a first control action and/or a second control action. The first control action may be associated with controlling a movement of a damper associated with at least one zone, from among the plurality of zones, of the HVAC system. In an embodiment of the disclosure, triggering the first control action may comprise closing a damper associated with at least one zone other than the zone, from among the plurality of zones, thereby minimizing flow of smoke from the zone to the at least one other zone. In another embodiment of the disclosure, triggering the first control action comprises closing a damper associated with the zone, from among the plurality of zones, thereby minimizing flow of smoke from the zone to the at least one other zone.

In an embodiment of the disclosure, the second control action may be associated with the HVAC system. The second control action may comprise supplying fresh air from the outdoor environment to at least one zone, from among the plurality of zones 102a-102d, while operating the HVAC system.

While the above steps of FIG. 3 are shown and described in a particular sequence, the steps may occur in variations to the sequence in accordance with various embodiments of the disclosure. Further, a detailed description related to various steps of FIG. 3, which are already covered in the description related to FIGS. 1-2 is omitted herein for the sake of brevity of the disclosure.

The above discussed embodiments in the disclosure facilitate in protecting premises from fire by utilizing existing HVAC systems in such premises, without any fire/smoke sensors. The disclosure may further facilitate fire detection and implementing control actions in residential buildings, hotels, hospitals, and/or commercial buildings based on limited modifications to HVAC systems (e.g., software modifications) and without any additional/new installations of fire/smoke sensors, thereby saving time, efforts, and costs. Additionally, the disclosure provides strong measures to avoid any fake fire alerts by using a two-step methodology of comparing current temperature values with OAT value and subsequently comparing rate of change of current temperature values with predefined threshold values. Therefore, the disclosure allows for supplementing fire detection with additional already available sensors to better cover more square footage of the dwelling/building.

While specific language has been used to describe the subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. A method of generating fire alerts for an indoor environment having a plurality of zones and a Heating Ventilation and Air Conditioning (HVAC) system, the method comprising:
receiving, from an outside air temperature (OAT) sensor of the HVAC system, a current outside temperature value for an outdoor environment;
receiving, from a zone sensor associated with the HVAC system, a current zone temperature value associated with a corresponding zone, from among the plurality of zones, in the indoor environment;
determining whether the current zone temperature value is greater than the current outside temperature value;
detecting, when the current zone temperature value is greater than the current outside temperature value, whether a rate of change of the current zone temperature value is greater than a predefined threshold value; and
generating a fire alert for the zone when the rate of change of the current zone temperature value is detected to be greater than the predefined threshold value.

2. The method of claim 1, wherein generating the fire alert comprises generating a first alert notification for one of a graphical user interface (GUI) associated with the HVAC system or a third-party fire safety control system, wherein the first alert notification is indicative of fire within the zone.

3. The method of claim 1, further comprising:
triggering a first control action associated with controlling a movement of a damper associated with at least one zone, from among the plurality of zones, of the HVAC system.

4. The method of claim 3, wherein triggering the first control action comprises closing a damper associated with at least one zone other than the zone, from among the plurality of zones, thereby minimizing flow of smoke from the zone to the at least one other zone.

5. The method of claim 3, wherein triggering the first control action comprises closing a damper associated with the zone, from among the plurality of zones, thereby minimizing flow of smoke from the zone to the at least one other zone.

6. The method of claim 1, further comprising:
triggering a second control action associated with the HVAC system, wherein the second control action comprises supplying fresh air from the outdoor environment to at least one zone, from among the plurality of zones, while operating the HVAC system.

7. The method of claim 1, wherein the detecting comprises iteratively detecting, over a period of time, that the rate of change of the current zone temperature value is greater than the predefined threshold value when the current zone temperature value is detected to be greater than the current outside temperature value, and
wherein the generating comprises generating the fire alert for the zone in response to detecting, over the period of time, a predefined number of times that the rate of change of the current zone temperature value is greater than the predefined threshold value.

8. A Heating Ventilation and Air Conditioning (HVAC) system to generate fire alerts for an indoor environment having a plurality of zones, the HVAC system comprising:
at least one HVAC equipment, and
at least one control device communicatively connected with the at least one HVAC equipment, the at least one control device comprising a processor configured to, for each of the plurality of zones:
receive, from an outside air temperature (OAT) sensor of the HVAC equipment, a current outside temperature value for an outdoor environment;
receive, from a corresponding zone sensor associated with the HVAC equipment, a current zone temperature value associated with a corresponding zone, from among the plurality of zones, in the indoor environment;
determine whether the current zone temperature value is greater than the current outside temperature value;
detect, when the current zone temperature value is greater than the current outside temperature value, whether a rate of change of the current zone temperature value is greater than a predefined threshold value; and
generate a fire alert for the zone when the rate of change of the current zone temperature value is detected to be greater than the predefined threshold value.

9. The HVAC system of claim 8, wherein to generate the fire alert, the processor is configured to generate a first alert notification for one of a graphical user interface (GUI) associated with the HVAC system or a third-party fire safety control system, wherein the first alert notification is indicative of fire within the zone.

10. The HVAC system of claim 8, wherein the processor is further configured to:
trigger a first control action associated with controlling a movement of a damper associated with at least one zone, from among the plurality of zones, of the HVAC system.

11. The HVAC system of claim 10, wherein to trigger the first control action, the processor is configured to close a damper associated with at least one zone other than the zone, from among the plurality of zones, thereby minimizing flow of smoke from the zone to the at least one other zone.

12. The HVAC system of claim 10, wherein to trigger the first control action, the processor is configured to close a damper associated with the zone, from among the plurality of zones, thereby minimizing flow of smoke from the zone to the at least one other zone.

13. The HVAC system of claim 8, wherein the processor is further configured to:
trigger a second control action associated with the HVAC system, wherein the second control action comprises supplying fresh air from the outdoor environment to at least one zone, from among the plurality of zones, while operating the HVAC system.

14. The HVAC system of claim 8, wherein the processor is further configured to:
iteratively detect, over a period of time, that the rate of change of the current zone temperature value is greater than the predefined threshold value when the current zone temperature value detected to be is greater than the current outside temperature value, and
generate the fire alert for the zone in response to detecting, over the period of time, a predefined number of times that the rate of change of the current zone temperature value is greater than the predefined threshold value.
